(19) United States
(12) Patent Application Publication
(10) Pub. No.: US 2025/0011479 A1
(43) Pub. Date: Jan. 9, 2025

(54) IRON-BASED CATALYST AND ITS APPLICATION IN CATALYTIC DIENE POLYMERIZATION

(71) Applicant: QINGDAO UNIVERSITY OF SCIENCE AND TECHNOLOGY, Qingdao (CN)

(72) Inventors: Chunyu ZHANG, Qingdao (CN); Yingnan ZHAO, Qingdao (CN); Lihua NA, Qingdao (CN); Heng LIU, Qingdao (CN); Xuequan ZHANG, Qingdao (CN)

(73) Assignee: QINGDAO UNIVERSITY OF SCIENCE AND TECHNOLOGY, Qingdao (CN)

(21) Appl. No.: 18/751,816

(22) Filed: Jun. 24, 2024

(30) Foreign Application Priority Data
Jul. 3, 2023 (CN) 202310804651.5

(51) Int. Cl. C08F 4/80; C08F 2/06; C08F 6/10; C08F 36/06; C08F 36/08

(52) U.S. Cl. CPC C08F 4/80; C08F 2/06; C08F 6/10; C08F 36/06; C08F 36/08; C08F 2400/02; C08F 2410/01

(57) ABSTRACT

Disclosed are an iron-based catalyst and its application catalytic diene polymerization. The iron-based catalyst provided by the present application includes iron-containing organic compounds, alkyl aluminum compounds and isocyanide-containing organic compounds, and the molar ratio between the iron element of the iron-containing organic compounds, the alkyl aluminum compounds and the isocyanide-containing organic compounds is 1:(5˜100):(0.5˜100). The iron-based catalyst system of the present application can initiate polymerization of diene with high activity at high temperature by using isocyanide-containing organic compounds as an electron donor and alkyl aluminum compounds as a co-catalyst.

### CROSS-REFERENCE TO RELATED APPLICATIONS

This application claims priority to Chinese Patent Application No. 202310804651.5, filed on Jul. 3, 2023, the content of which is incorporated herein by reference in its entirety.

### TECHNICAL FIELD

The present application relates to the technical field of polymer synthesis, and specifically relates to an iron-based catalyst and its application in catalytic diene polymerization.

### BACKGROUND

Iron-based catalysts are non-toxic, green, environmentally friendly, biocompatible, inexpensive and easy to obtain, and can be applied in catalytic diene polymerization to obtain syndiotactic 1,2-polybutadiene and polyisoprene polymers with 3,4-structures. Brigestone Co., Japan, recently developed an iron-based catalyst with the addition of dialkyl phosphite [HP(O)(OR)2] or cyclic phosphite as the electron donor and using aliphatic hydrocarbons as the solvent to produce high crystallinity syndiotactic 1,2-polybutadiene with a melting temperature of 160° C.-180° C. (EP0994129A1, EP0994130A, U.S. Pat. No. 627,779, WO0149753A1). The dialkyl phosphite used in the catalyst is not only an intermediate in the preparation of pesticides, which decomposes easily in contact with water to release toxic and health-hazardous phosphorus oxide fumes, but also a chemical subject to transportation restrictions. This also affects the wide application of this catalyst system to a certain extent. At the same time, the syndiotactic 1,2-polybutadiene thermoplastic elastomer prepared by this catalytic system forms a pseudo-gel-like substance during polymerization, so that the uniform dispersal of the antioxidant into the polymer is difficult to achieve during processing, which can lead to gelation of the polymer during post-treatment and processing. In order to solve the problem of hydrolysis of dialkyl esters of salt phosphates, Zhang Xuequan et al. developed a systematic catalyst system with a less toxic and stable diaryl phosphite or aryl phosphate reagent as ligand (CN1260259C). To solve the gelation problem Brigestone used polymerization at high temperature (80° C.) and the addition of antioxidant 2,6-dialkyl-4-(dialkyl aminomethyl) phenol (US 2003/0040594A1); while Zhang Xuequan et al. used the system of ferric isooctanoate/phosphite diester/trialkyl aluminum, with the addition of 2,6-dialkyl-4-(dialkyl aminomethyl) phenol, as a catalyst to prepare thermally stabilized syndiotactic 1,2-polybutadiene thermoplastic elastomers.

Although the above iron-based catalysts can produce syndiotactic 1,2-polybutadiene elastomers and the polymerization activity of the catalyst system is high, there are still the following problems: firstly, iron is a variable element, and the presence of a certain concentration of iron ions will lead to the occurrence of accelerated aging of rubber materials; secondly, the melting point of syndiotactic 1,2-polybutadiene elastomers prepared with iron catalysts is in the range of 150-170° C., and the high melting point will bring about the problem of not being able to mix evenly with other rubbers when mixing. Therefore, the development of higher activity catalysts to adjust the melting point of syndiotactic 1,2-polybutadiene elastomers is an important development direction for iron-based syndiotactic 1,2-polybutadiene elastomers.

The polymerization reaction of isoprene catalyzed by using an iron-based catalytic system can obtain polyisoprene polymers with 3,4-structures, but the polymerization reaction has the disadvantage of only being able to carry out at low-temperature; at the same time, the iron compounds are not valence stable in the presence of alkyl aluminum, and are easy to reduce to generate a variety of reactive centers or transition states, generating radicals etc. and leading to an uncontrollable polymerization process, which results in the product containing oligomers and having a complex structure with a low stereospecificity [Polym Lett 1964 2 (6), 593-596.]. Nitrogen-containing ligands or electron-donors acting as third components are able to stabilize the active center to a certain extent and improve polymerization activity and stereoselectivity [Bull Chem Soc Japan 1965, 38 (8), 1243-1247; J Cat 1970, 17, 331-340; Macromolecules 2003, 36, 7953-7958; Synthetic Rubber Industry 2004, 27 (6, 344-347.]. Sun Jing et al [Journal of Macromolecules 1988, 2, 145-148] synthesized for the first time at low temperatures crystalline 3,4-polyisoprene rubber with a 3,4-link content of about 70% and Tm and Tc of 121° C. and 65° C., respectively, by using a catalytic system of ferric acetylacetonate (Fe(acac)3)/alkyl aluminum and nitrogen-containing class of electron donors. Although the research on iron-based catalysts and their ligand/electron-donor third components has persisted up to now, the problems of low-temperature polymerization and the still insufficient polymerization activity have not been well solved.

### SUMMARY

The present application aims to overcome the drawbacks of the prior art and provide an iron-based catalyst and its application in catalytic diene polymerization.

In order to achieve the above objects, the technical solution of the present application is: an iron-based catalyst comprising iron-containing organic compounds, alkyl aluminum compounds and isocyanide-containing organic compounds, wherein the molar ratio between iron element in the iron-containing organic compounds, alkyl aluminum compounds and isocyanide-containing organic compounds is 1:(5˜100):(0.5˜100), preferably 1:(10˜50):(1˜50).

Furthermore, the iron-containing organic compounds comprise one or more of the following: ferric acetylacetonate, ferric naphthenate, ferric neodecanoate, and ferric isooctanoate.

Furthermore, the alkyl aluminum compounds comprise one or more of the following: triethyl aluminum, triisobutyl aluminum, diisobutyl aluminum hydride, diisobutyl aluminum chloride.

Furthermore, the isocyanide-containing organic compounds comprise one or more of the following: ethyl isocyanoacetate, methyl isocyanoacetate, tert-butyl isocyanoacetate, 1,1,3,3-tetramethylbutylisocyanide, and (isocyanimino)triphenylphosphorane.

Another technical solution of the present application is: an application of an iron-based catalyst in catalytic diene polymerization, wherein the iron catalyst and dienes are mixed and a polymerization reaction is carried out, and after the polymerization is completed, ethanol is added to terminate the reaction, the solvent is filtered off, and a polymer product is obtained after vacuum drying;

The molar ratio of iron in the iron-containing organic compounds to dienes is 1:(1000˜100000), preferably 1:(5000˜50000);

Forms of the dienes comprise a liquid diene body or a diene solution;

A solvent for the diene solution is a hydrocarbon solvent.

Furthermore, the dienes are butadiene or isoprene.

Furthermore, the hydrocarbon organic solvent is one or more of the following: benzene, toluene, xylene, hexane, cyclohexane, pentane, heptane, octane.

Furthermore, the iron-based catalyst is added in a sequential order of iron-containing organic compounds, isocyanide-containing organic compounds, and alkyl aluminum compounds.

Furthermore, the temperature and reaction time of the polymerization reaction is from 30 to 100° C., and from 0.5 to 4 hours.

The beneficial effect of the present application is that its iron-based catalyst system can initiate polymerization of dienes with high activity at high temperature by using isocyanide-containing organic compounds as electron donor and alkyl aluminum compounds as co-catalyst.

When catalyzing isoprene polymerization, the reaction has reactivity >1360 kg/mol-Fe-h, short polymerization time, high polymer regularity, tunable polymer structure, higher content of 3,4-(+1,2-) structure in the prepared polybutadiene, and the ability to prepare crystallizable polyisoprene with trans-1,4-structure.

When catalyzing butadiene polymerization, the reaction has reactivity >1000 Kg/mol-Fe-h and the prepared syndiotactic 1,2-polybutadiene elastomers are gel free and have a melting point of 80-130° C. and crystallinity of 10-30%.

### BRIEF DESCRIPTION OF THE DRAWINGS

FIG. 1 is a 1H-nuclear magnetic resonance (1H-NMR) spectrum of a polymer sample obtained in Embodiment 5.

FIG. 2 is a differential scanning calorimetry (DSC) spectrogram of a polymer sample obtained in Embodiments 5, 10 and 14.

FIG. 3 is a gel permeation chromatography (GPC) spectrogram of a polymer sample obtained from Embodiments 13 and 15.

FIG. 4 is a 1H-NMR spectrum of the polymer sample obtained in Embodiment 22.

FIG. 5 is a DSC spectrum of the polymer sample obtained in Embodiment 22.

FIG. 6 is a 1H-NMR spectrum of a polymer sample obtained from Embodiment 23.

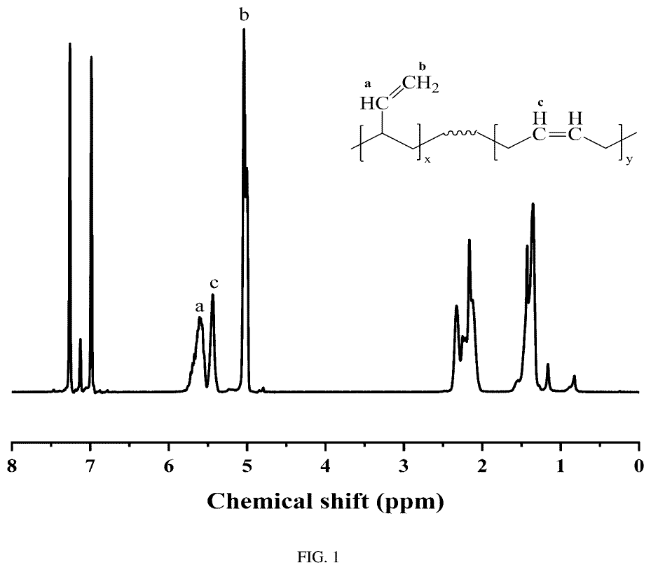

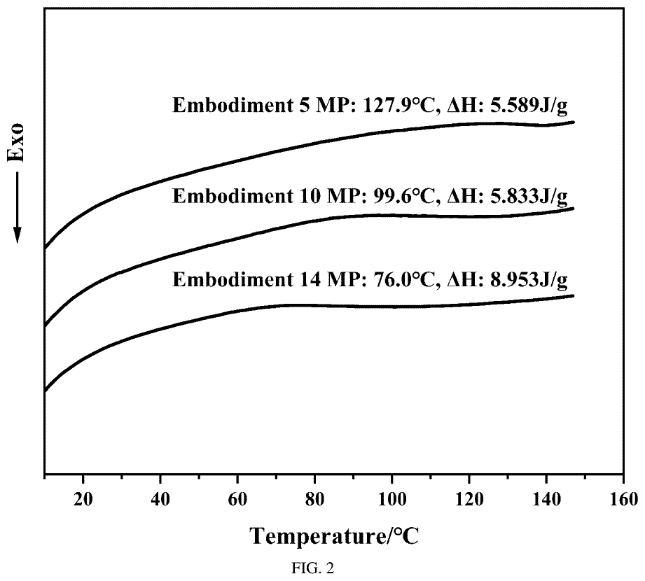

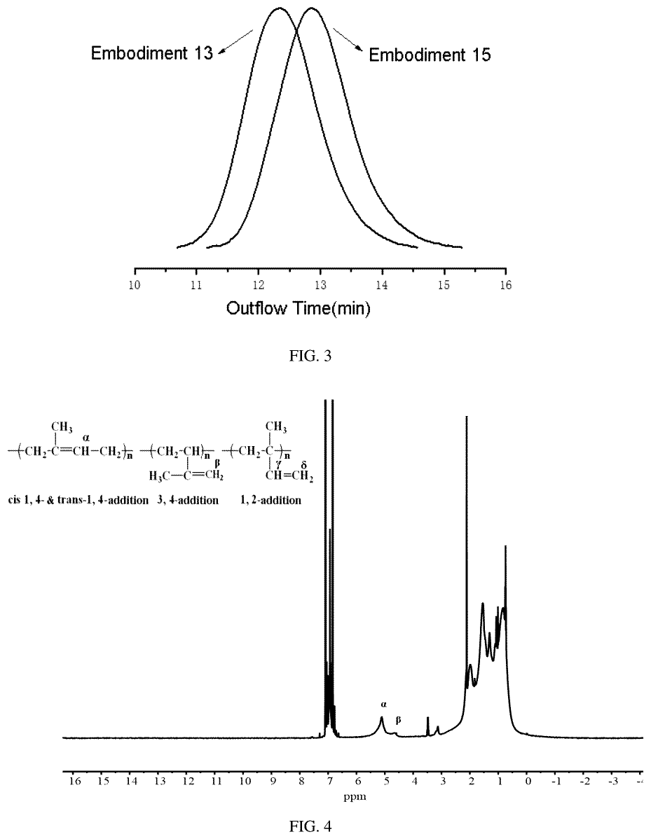

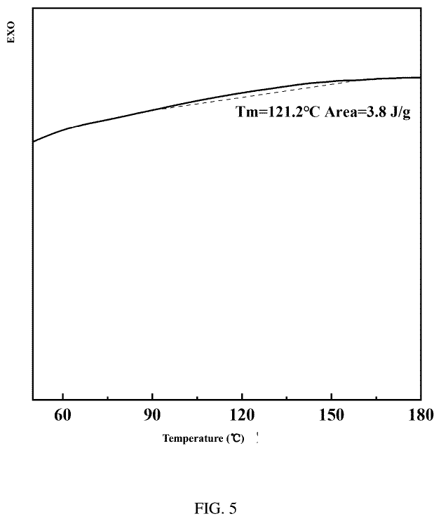

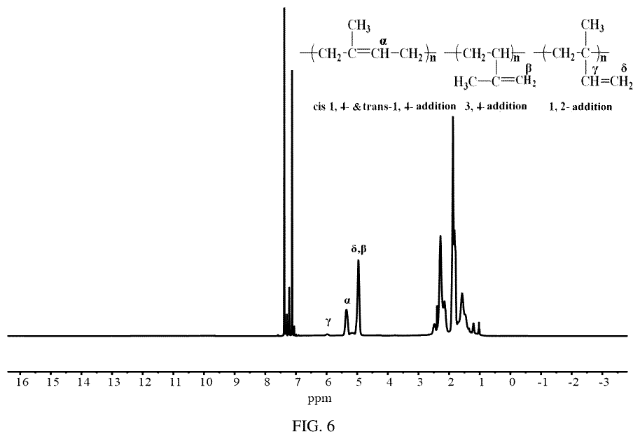

### DETAILED DESCRIPTION OF THE EMBODIMENTS

The gel content (Gel) in the embodiments and comparison examples of the present application was tested according to the standards of SH/T 1050-2014.

A “-” in the table indicates that the corresponding physical and chemical parameters were not tested.

### Comparison Example 1

Under the protection of nitrogen, 84 ml of dry hexane and 10 g of dry butadiene were added into an oven-dried single-necked 120 ml reaction flask. The following reagents were sequentially added: 0.0185 mmol of ferric isooctanoate, 0.037 mmol of azodiisobutyronitrile (AIBN), 0.37 mmol of triisobutyl aluminum (TIBA). Subsequently, the flask was put into a water bath at a constant temperature of 50° C. for polymerization to proceed for 2 hours. Ethanol was added to terminate the reaction, and the substance in the flask was filtered to obtain a solid product which was then evacuated and dried in a vacuum drying oven to constant weight to obtain a polymer sample of 9.95 g with a yield of 99.5% and a gel content of 78.2%.

### Embodiment 1

Under the protection of nitrogen, 84 ml of dry hexane and 10 g of dry butadiene were added into an oven-dried single-necked 120 ml reaction flask. The following reagents were sequentially added: 0.0185 mmol of ferric acetylacetonate, 0.037 mmol of ethyl isocyanoacetate, 0.4625 mmol of triisobutyl aluminum (TIBA). Subsequently, the flask was put into a water bath at a constant temperature of 50° C. for polymerization to proceed for 2 hours. Ethanol was added to terminate the reaction, and the substance in the flask was filtered to obtain a solid product which was then evacuated and dried in a vacuum drying oven to constant weight to obtain a polymer sample of 7.02 g, whose physical and chemical parameters are shown in Table 1.

### Embodiment 2

Under the protection of nitrogen, 84 ml of dry hexane and 10 g of dry butadiene were added into an oven-dried single-necked 120 ml reaction flask. The following reagents were sequentially added: 0.0185 mmol of ferric acetylacetonate, 0.037 mmol of methyl isocyanoacetate, 0.4625 mmol of triisobutyl aluminum (TIBA). Subsequently, the flask was put into a water bath at a constant temperature of 50° C. for polymerization to proceed for 2 hours. Ethanol was added to terminate the reaction, and the substance in the flask was filtered to obtain a solid product which was then evacuated and dried in a vacuum drying oven to constant weight to obtain a polymer sample of 6.08 g, whose physical and chemical parameters are shown in Table 1.

### Embodiment 3

Under the protection of nitrogen, 84 ml of dry hexane and 10 g of dry butadiene were added into an oven-dried single-necked 120 ml reaction flask. The following reagents were sequentially added: 0.0185 mmol of ferric acetylacetonate, 0.037 mmol of tert-butyl isocyanoacetate, 0.4625 mmol of triisobutyl aluminum (TIBA). Subsequently, the flask was put into a water bath at a constant temperature of 50° C. for polymerization to proceed for 2 hours. Ethanol was added to terminate the reaction, and the substance in the flask was filtered to obtain a solid product which was then evacuated and dried in a vacuum drying oven to constant weight to obtain a polymer sample of 7.53 g, whose physical and chemical parameters are shown in Table 1.

### Embodiment 4

Under the protection of nitrogen, 84 ml of dry hexane and 10 g of dry butadiene were added into an oven-dried single-necked 120 ml reaction flask. The following reagents were sequentially added: 0.0185 mmol of ferric acetylacetonate, 0.037 mmol of 1,1,3,3-tetramethylbutylisocyanide, 0.4625 mmol of triisobutyl aluminum (TIBA). Subsequently, the flask was put into a water bath at a constant temperature of 50° C. for polymerization to proceed for 2 hours. Ethanol was added to terminate the reaction, and the substance in the flask was filtered to obtain a solid product which was then evacuated and dried in a vacuum drying oven to constant weight to obtain a polymer sample of 8.94 g, whose physical and chemical parameters are shown in Table 1.

### Embodiment 5

Under the protection of nitrogen, 84 ml of dry hexane and 10 g of dry butadiene were added into an oven-dried single-necked 120 ml reaction flask. The following reagents were sequentially added: 0.0185 mmol of ferric acetylacetonate, 0.037 mmol of (isocyanimino)triphenylphosphorane, 0.4625 mmol of triisobutyl aluminum (TIBA). Subsequently, the flask was put into a water bath at a constant temperature of 50° C. for polymerization to proceed for 2 hours. Ethanol was added to terminate the reaction, and the substance in the flask was filtered to obtain a solid product which was then evacuated and dried in a vacuum drying oven to constant weight to obtain a polymer sample of 10 g, whose physical and chemical parameters are shown in Table 1.

TABLE 1

| | | Melting | 1,2- | | |
|---|---|---|---|---|---|
| | | Temperature | structure | | |
| | Yield | (Tₘ) | content | Crystallinity | Gel |
| Embodiments | % | ° C. | % | % | % |
| Embodiment | 70.2 | 82.3 | 65.3 | 9.5 | 0 |
| 1 | | | | | |
| Embodiment | 60.8 | — | — | — | — |
| 2 | | | | | |
| Embodiment | 75.3 | 90.1 | 73.4 | 6.7 | 0 |
| 3 | | | | | |
| Embodiment | 89.4 | 92.5 | 73.8 | 10.3 | 0 |
| 4 | | | | | |
| Embodiment | 100 | 127.9 | 75.8 | 12.9 | 0 |
| 5 | | | | | |

### Embodiment 6

Under the protection of nitrogen, 84 ml of dry hexane and 10 g of dry butadiene were added into an oven-dried single-necked 120 ml reaction flask. The following reagents were sequentially added: 0.0185 mmol of ferric isooctanoate, 0.037 mmol of (isocyanimino)triphenylphosphorane, 0.37 mmol of triisobutyl aluminum (TIBA). Subsequently, the flask was put into a water bath at a constant temperature of 70° C. for polymerization to proceed for 2 hours. Ethanol was added to terminate the reaction, and the substance in the flask was filtered to obtain a solid product which was then evacuated and dried in a vacuum drying oven to constant weight to obtain a polymer sample of 8.91 g with a yield of 89.1%, a melting temperature of 125.6° C., a 1,2-structure content of 80.2% and a crystallinity of 20.0%.

### Embodiment 7

Under the protection of nitrogen, 84 ml of dry hexane and 10 g of dry butadiene were added into an oven-dried single-necked 120 ml reaction flask. The following reagents were sequentially added: 0.185 mmol of ferric isooctanoate, 0.37 mmol of (isocyanimino)triphenylphosphorane, 3.7 mmols of triisobutyl aluminum. Subsequently, the flask was put into a water bath at a constant temperature of 50° C. for polymerization to proceed for 2 hours. Ethanol was added to terminate the reaction, and the substance in the flask was filtered to obtain a solid product which was then evacuated and dried in a vacuum drying oven to constant weight to obtain a polymer sample of 9.95 g with a yield of 99.5%, a melting temperature of 77.6° C., a 1,2-structure content of 64.55 and a crystallinity of 9.5%.

### Embodiment 8

Under the protection of nitrogen, 84 ml of dry hexane and 10 g of dry butadiene were added into an oven-dried single-necked 120 ml reaction flask. The following reagents were sequentially added: 0.0925 mmol of ferric isooctanoate, 0.04625 mmol of (isocyanimino)triphenylphosphorane, 2.3125 mmols of triisobutyl aluminum. Subsequently, the flask was put into a water bath at a constant temperature of 30° C. for polymerization to proceed for 1 hour. Ethanol was added to terminate the reaction, and the substance in the flask was filtered to obtain a solid product which was then evacuated and dried in a vacuum drying oven to constant weight to obtain a polymer sample of 6.0 g, whose physical and chemical parameters are shown in Table 2.

### Embodiment 9

Under the protection of nitrogen, 84 ml of dry toluene and 10 g of dry butadiene were added into an oven-dried single-necked 120 ml reaction flask. The following reagents were sequentially added: 0.0925 mmol of ferric isooctanoate, 0.185 mmol of (isocyanimino)triphenylphosphorane, 2.3125 mmols of triisobutyl aluminum. Subsequently, the flask was put into a water bath at a constant temperature of 50° C. for polymerization to proceed for 1 hour. Ethanol was added to terminate the reaction, and the substance in the flask was filtered to obtain a solid product which was then evacuated and dried in a vacuum drying oven to constant weight to obtain a polymer sample of 9.69 g, whose physical and chemical parameters are shown in Table 2.

### Embodiment 10

Under the protection of nitrogen, 84 ml of dry dichloromethane and 10 g of dry butadiene were added into an oven-dried single-necked 120 ml reaction flask. The following reagents were sequentially added: 0.0925 mmol of ferric isooctanoate, 0.2775 mmol of (isocyanimino)triphenylphosphorane, 2.3125 mmols of triisobutyl aluminum. Subsequently, the flask was put into a water bath at a constant temperature of 70° C. for polymerization to proceed for 1 hour. Ethanol was added to terminate the reaction, and the substance in the flask was filtered to obtain a solid product which was then evacuated and dried in a vacuum drying oven to constant weight to obtain a polymer sample of 9.02 g, whose physical and chemical parameters are shown in Table 2.

### Embodiment 11

Under the protection of nitrogen, 84 ml of dry hexane and 10 g of dry butadiene were added into an oven-dried single-necked 120 ml reaction flask. The following reagents were sequentially added: 0.0925 mmol of ferric isooctanoate, 0.185 mmol of (isocyanimino)triphenylphosphorane, 2.3125 mmols of triisobutyl aluminum. Subsequently, the flask was put into a water bath at a constant temperature of 30° C. for polymerization to proceed for 1 hour. Ethanol was added to terminate the reaction, and the substance in the flask was filtered to obtain a solid product which was then evacuated and dried in a vacuum drying oven to constant weight to obtain a polymer sample of 5.52 g, whose physical and chemical parameters are shown in Table 2.

### Embodiment 12

Under the protection of nitrogen, 84 ml of dry toluene and 10 g of dry butadiene were added into an oven-dried single-necked 120 ml reaction flask. The following reagents were sequentially added: 0.0925 mmol of ferric isooctanoate, 0.925 mmol of (isocyanimino)triphenylphosphorane, 2.3125 mmols of triisobutyl aluminum. Subsequently, the flask was put into a water bath at a constant temperature of 100° C. for polymerization to proceed for 1 hour. Ethanol was added to terminate the reaction, and the substance in the flask was filtered to obtain a solid product which was then evacuated and dried in a vacuum drying oven to constant weight to obtain a polymer sample of 9.33 g, whose physical and chemical parameters are shown in Table 2.

TABLE 2

| | | | | 1,2- | |
|---|---|---|---|---|---|
| | Reaction | | | structure | |
| | Temperature | Yield | Tₘ | content | Crystallinity |
| Embodiments | ° C. | % | ° C. | % | % |
| Embodiment 8 | 30 | 60 | 90.2 | 75.3 | 18.2 |
| Embodiment 9 | 50 | 96.9 | 95.3 | 78.2 | 23.4 |
| Embodiment 10 | 70 | 90.2 | 99.6 | 79.6 | 24.3 |
| Embodiment 11 | 30 | 55.2 | 76.0 | 76.3 | 13.2 |
| Embodiment 12 | 100 | 93.3 | 108.5 | 81.2 | 29.6 |

### Embodiment 13

Under the protection of nitrogen, 84 ml of dry hexane and 10 g of dry butadiene were added into an oven-dried single-necked 120 ml reaction flask. The following reagents were sequentially added: 0.0925 of mmol of ferric naphthenate, 0.185 mmol (isocyanimino)triphenylphosphorane, 0.925 mmol of triethyl aluminum. Subsequently, the flask was put into a water bath at a constant temperature of 70° C. for polymerization to proceed for 2 hours. Ethanol was added to terminate the reaction, and the substance in the flask was filtered to obtain a solid product which was then evacuated and dried in a vacuum drying oven to constant weight to obtain a polymer sample of 9.69 g, whose physical and chemical parameters are shown in Table 3.

### Embodiment 14

Under the protection of nitrogen, 84 ml of dry hexane and 10 g of dry butadiene were added into an oven-dried single-necked 120 ml reaction flask. The following reagents were sequentially added: 0.0616 mmol of ferric naphthenate, 0.1232 mmol of (isocyanimino)triphenylphosphorane, 1.23 mmols of triethyl aluminum. Subsequently, the flask was put into a water bath at a constant temperature of 70° C. for polymerization to proceed for 2 hours. Ethanol was added to terminate the reaction, and the substance in the flask was filtered to obtain a solid product which was then evacuated and dried in a vacuum drying oven to constant weight to obtain a polymer sample of 9.94 g, whose physical and chemical parameters are shown in Table 3.

### Embodiment 15

Under the protection of nitrogen, 84 ml of dry hexane and 10 g of dry butadiene were added into an oven-dried single-necked 120 ml reaction flask. The following reagents were sequentially added: 0.04625 mmol of ferric naphthenate, 0.0925 mmol of (isocyanimino)triphenylphosphorane, 1.3875 mmols of diisobutyl aluminum hydride. Subsequently, the flask was put into a water bath at a constant temperature of 70° C. for polymerization to proceed for 2 hours. Ethanol was added to terminate the reaction, and the substance in the flask was filtered to obtain a solid product which was then evacuated and dried in a vacuum drying oven to constant weight to obtain a polymer sample of 9.64 g, whose physical and chemical parameters are shown in Table 3.

### Embodiment 16

Under the protection of nitrogen, 84 ml of dry hexane and 10 g of dry butadiene were added into an oven-dried single-necked 120 ml reaction flask. The following reagents were sequentially added: 0.06166 mmol of ferric naphthenate, 0.1233 mmol of (isocyanimino)triphenylphosphorane, 1.233 mmols of diisobutyl aluminum chloride. Subsequently, the flask was put into a water bath at a constant temperature of 70° C. for polymerization to proceed for 2 hours. Ethanol was added to terminate the reaction, and the substance in the flask was filtered to obtain a solid product which was then evacuated and dried in a vacuum drying oven to constant weight to obtain a polymer sample of 8.05 g, whose physical and chemical parameters are shown in Table 3.

### Embodiment 17

Under the protection of nitrogen, 84 ml of dry hexane and 10 g of dry butadiene were added into an oven-dried single-necked 120 ml reaction flask. The following reagents were sequentially added: 0.0308 mmol of ferric naphthenate, 0.0616 mmol of (isocyanimino)triphenylphosphorane, 0.925 mmol of triisobutyl aluminum. Subsequently, the flask was put into a water bath at a constant temperature of 70° C. for polymerization to proceed for 2 hours. Ethanol was added to terminate the reaction, and the substance in the flask was filtered to obtain a solid product which was then evacuated and dried in a vacuum drying oven to constant weight to obtain a polymer sample of 4.44 g, whose physical and chemical parameters are shown in Table 3.

### Embodiment 18

Under the protection of nitrogen, 84 ml of dry hexane and 10 g of dry butadiene were added into an oven-dried single-necked 120 ml reaction flask. The following reagents were sequentially added: 0.0185 mmol of ferric naphthenate, 0.037 mmol of (isocyanimino)triphenylphosphorane, 1.85 mmols of triisobutyl aluminum. Subsequently, the flask was put into a water bath at a constant temperature of 70° C. for polymerization to proceed for 2 hours. Ethanol was added to terminate the reaction, and the substance in the flask was filtered to obtain a solid product which was then evacuated and dried in a vacuum drying oven to constant weight to obtain a polymer sample of 1.03 g, whose physical and chemical parameters are shown in Table 3.

TABLE 3

| | | | | | Weight |
|---|---|---|---|---|---|
| | | | 1,2- | | Average |
| | | | structure | | Molecular |
| | Yield | Tₘ | content | Crystallinity | Weight |
| Embodiments | % | ° C. | % | % | 10⁴ |
| Embodiment 13 | 96.9 | 76.0 | 75.8 | 11.2 | 43.8 |
| Embodiment 14 | 99.4 | 110.3 | 83.2 | 20.1 | 50.2 |
| Embodiment 15 | 96.4 | 127.9 | 80.2 | 18.5 | 20.1 |
| Embodiment 16 | 80.5 | 100.2 | 40.2 | 10.3 | 18.4 |
| Embodiment 17 | 44.4 | 112.3 | 80.2 | 10.3 | 60.2 |
| Embodiment 18 | 10.3 | — | — | — | — |

### Comparison Example 2

Under the protection of nitrogen, 49 ml of dry hexane and 10 g of dry isoprene were added into an oven-dried single-necked 120 ml reaction flask. The following reagents were sequentially added: 29.36 umols of ferric isooctanoate, 88 umols of AIBN, 88 umols of triisobutyl aluminum (TIBA). Subsequently, the flask was put into a water bath at a constant temperature of 50° C. for polymerization to proceed for 4 hours. Ethanol was added to terminate the reaction, and the substance in the flask was filtered to obtain a solid product which was then evacuated and dried in a vacuum drying oven to constant weight to obtain a polymer sample of 9.97 g with a yield of 99.5%, a 1,2-/3,4-/1,4-structure content (%) of 5.6/38.8/55.6, and a glass-transition temperature (Tg) of −17.2° C.

### Comparison Example 3

Under the protection of nitrogen, 49 ml of dry hexane and 10 g of dry isoprene were added into an oven-dried single-necked 120 ml reaction flask. The following reagents were sequentially added: 29.36 umols of ferric acetylacetonate, 58.7 umols of diethyl phosphite (DEP), 1.174 mmols of triisobutyl aluminum (TIBA). Subsequently, the flask was put into a water bath at a constant temperature of 50° C. for polymerization to proceed for 4 hours. Ethanol was added to terminate the reaction, and the substance in the flask was filtered to obtain a solid product which was then evacuated and dried in a vacuum drying oven to constant weight to obtain a polymer sample of 1.47 g with a yield of 14.7%, a 1,2-/3,4-/1,4-structure content (%) of 15.4/22.9/61.7, and a Tg of −18.9° C.

### Embodiment 19

Under the protection of nitrogen, 49 ml of dry hexane and 10 g of dry isoprene were added into an oven-dried single-necked 120 ml reaction flask. The following reagents were sequentially added: 7.34 umols of ferric acetylacetonate, 7.34 umols of (isocyanimino)triphenylphosphorane, 1.174 mmols of triethyl aluminum. Subsequently, the flask was put into a water bath at a constant temperature of 70° C. for polymerization to proceed for 20 minutes. Ethanol was added to terminate the reaction, and the substance in the flask was filtered to obtain a solid product which was then evacuated and dried in a vacuum drying oven to constant weight to obtain a polymer sample of 5.38 g with a yield of 53.8%, a 1,2-/3,4-/1,4-structure content (%) of 4.9/46.1/49.0, and a Tg of −14.1° C.

### Embodiment 20

Under the protection of nitrogen, 49 ml of dry hexane and 10 g of dry isoprene were added into an oven-dried single-necked 120 ml reaction flask. The following reagents were sequentially added: 4.89 umols of ferric neodecanoate, 14.68 umols of (isocyanimino)triphenylphosphorane, 244.7 umols of diisobutyl aluminum hydride. Subsequently, the flask was put into a water bath at a constant temperature of 50° C. for polymerization to proceed for 1 hour. Ethanol was added to terminate the reaction, and the substance in the flask was filtered to obtain a solid product which was then evacuated and dried in a vacuum drying oven to constant weight to obtain a polymer sample of 8.54 g with a yield of 85.4%, a 1,2-/3,4-/1,4-structure content (%) of 6.5/43.2/50.3, and a Tg of −15.8° C.

### Embodiment 21

Under the protection of nitrogen, 49 ml of dry hexane and 10 g of dry isoprene were added into an oven-dried single-necked 120 ml reaction flask. The following reagents were sequentially added: 1.468 umols of ferric acetylacetonate, 14.68 umols of (isocyanimino)triphenylphosphorane, 146.8 umols of diethyl aluminum hydride. Subsequently, the flask was put into a water bath at a constant temperature of 80° C. for polymerization to proceed for 4 hours. Ethanol was added to terminate the reaction, and the substance in the flask was filtered to obtain a solid product which was then evacuated and dried in a vacuum drying oven to constant weight to obtain a polymer sample of 8.46 g with a yield of 84.6%, a 1,2-/3,4-/1,4-structure content (%) of 3.6/44.8/51.6, and a Tg of −16.3° C.

### Embodiment 22

Under the protection of nitrogen, 49 ml of dry hexane and 10 g of dry isoprene were added into an oven-dried single-necked 120 ml reaction flask. The following reagents were sequentially added: 7.34 umols of ferric acetylacetonate, 22.02 umols of (isocyanimino)triphenylphosphorane, 220 umols of dichloroethyl aluminum. Subsequently, the flask was put into a water bath at a constant temperature of 50° C. for polymerization to proceed for 4 hours. Ethanol was added to terminate the reaction, and the substance in the flask was filtered to obtain a solid product which was then evacuated and dried in a vacuum drying oven to constant weight to obtain a polymer sample of 4.68 g with a yield of 46.8%, a 1,2-/3,4-/1,4-structure content (%) of 0.0/9.5/90.5, and a Tm of 121.2° C.

### Embodiment 23

Under the protection of nitrogen, 49 ml of dry hexane and 10 g of dry isoprene were added into an oven-dried single-necked 120 ml reaction flask. The following reagents were sequentially added: 7.34 umols of ferric acetylacetonate, 14.68 umols of (isocyanimino)triphenylphosphorane, 146.8 umols of triisobutyl aluminum (TIBA). Subsequently, the flask was put into a water bath at a constant temperature of 90° C. for polymerization to proceed for 0.5 hour. Ethanol was added to terminate the reaction, and the substance in the flask was filtered to obtain a solid product which was then evacuated and dried in a vacuum drying oven to constant weight to obtain a polymer sample of 9.98 g with a yield of 99.8%, a 1,2-/3,4-/1,4-structure content (%) of 6.3/44.9/48.8, and a Tg of −15.9° C.

### Embodiment 24

Under the protection of nitrogen, 49 ml of dry hexane and 10 g of dry isoprene were added into an oven-dried single-necked 120 ml reaction flask. The following reagents were sequentially added: 1.468 umols of ferric acetylacetonate, 14.68 umols of (isocyanimino)triphenylphosphorane, 146.8 umols of diethyl aluminum chloride. Subsequently, the flask was put into a water bath at a constant temperature of 80° C. for polymerization to proceed for 4 hours. Ethanol was added to terminate the reaction, and the substance in the flask was filtered to obtain a solid product which was then evacuated and dried in a vacuum drying oven to constant weight to obtain a polymer sample of 8.46 g with a yield of 84.6%, a 1,2-/3,4-/1,4-structure content (%) of 0.0/15.2/84.8, and a Tm of 116.3° C.

The above-mentioned embodiments are only the preferred solutions of the present application, and are not any form of limitation to it. There are other variants and adaptations without exceeding the technical solutions documented in the claims.

What is claimed is:

1. An iron-based catalyst, comprising iron-containing organic compounds, alkyl aluminum compounds and isocyanide-containing organic compounds, wherein a molar ratio between the iron element of the iron-containing organic compounds, the alkyl aluminum compounds and the isocyanide-containing organic compounds is 1:(5˜100):(0.5˜100).

2. The iron-based catalyst according to claim 1, wherein the iron-containing organic compounds comprise one or more of the following: ferric acetylacetonate, ferric naphthenate, ferric neodecanoate, and ferric isooctanoate.

3. The iron-based catalyst according to claim 1, wherein the alkyl aluminum compounds comprise one or more of the following: triethyl aluminum, triisobutyl aluminum, diisobutyl aluminum hydride, diisobutyl aluminum chloride.

4. The iron-based catalyst according to claim 1, wherein the isocyanide-containing organic compounds comprise one or more of the following: ethyl isocyanoacetate, methyl isocyanoacetate, tert-butyl isocyanoacetate, 1,1,3,3-tetramethylbutylisocyanide, and (isocyanimino)triphenylphosphorane.

5. An application of the iron catalyst described in claim 1 in catalytic diene polymerization, comprising steps of:
mixing the iron-based catalyst and dienes to carry out a polymerization reaction, adding ethanol to terminate the reaction, filtering, and getting a polymer product after vacuum drying; wherein
the molar ratio of iron in the iron-containing organic compounds to dienes is 1:(1000˜100000);
forms of the dienes comprise a liquid diene body or a diene solution, wherein the solvent for the diene solution is a hydrocarbon solvent.

6. The application of the iron-based catalyst in catalytic diene polymerization according to claim 5, wherein the dienes are butadiene or isoprene.

7. The application of the iron-based catalyst in catalytic diene polymerization according to claim 5, wherein the hydrocarbon organic solvent is one or more of the following: benzene, toluene, xylene, hexane, cyclohexane, pentane, heptane, and octane.

8. The application of the iron-based catalyst in catalytic diene polymerization according to claim 5, wherein the iron-based catalyst is added in a sequential order of iron-containing organic compounds, isocyanide-containing organic compounds, and alkyl aluminum compounds.

9. The application of the iron-based catalyst in catalytic diene polymerization according to claim 5, wherein the temperature and reaction time of the polymerization reaction is from 30 to 100° C., and from 0.5 to 4 hours.
